(19) United States
(12) Patent Application Publication
(10) Pub. No.: US 2019/0171505 A1
(43) Pub. Date: Jun. 6, 2019

(54) MANAGEMENT CONTROLLER-BASED SOLUTION FOR PROCESSOR RAS IN SMI-FREE ENVIRONMENT

(71) Applicant: Intel Corporation, Santa Clara, CA (US)

(72) Inventors: Murugasamy K. Nachimuthu, Beaverton, OR (US); Mohan J. Kumar, Aloha, OR (US)

(73) Assignee: Intel Corporation, Santa Clara, CA (US)

(21) Appl. No.: 15/829,934

(22) Filed: Dec. 3, 2017

(51) Int. Cl. G06F 11/00; G06F 11/07; G06F 12/10; G06F 9/455; H04L 12/58

(52) U.S. Cl. CPC G06F 11/008; G06F 11/0712; G06F 11/0772; G06F 12/10; G06F 9/45558; G06F 2009/45583; G06F 2201/875; G06F 2212/206; G06F 2212/657; G06F 2009/45591; H04L 51/22

(57) ABSTRACT

Management controller solutions for processor and platform RAS and associated methods, apparatus, and software. A computing platform including a processor coupled to at least one system memory device, a platform management controller (PMC), and a plurality of Reliability, Availability, and Serviceability (RAS) data sources. The PMC collects and/or receives RAS data from at least a portion of the plurality of RAS data sources using one or more out-of-band schemes and enables an operating system running on the computing platform to access the RAS data. The RAS data sources include machine specific registers and registers associated with various processor components and platform components. The RAS data includes SMART (Self-Monitoring, Analysis and Reporting Technology) data, as well as performance and/or health data. A MMIO scheme may be implemented to enable an operating system (OS) to access RAS data stored in on-board memory on the PMC. A platform management client mailbox employing doorbell rings may also be implemented to enable the OS to request access to RAS data and/or inform the OS that RAS data is available for access.

### BACKGROUND INFORMATION

During the past decade, there has been tremendous growth in the usage of so-called “cloud-hosted” services. Examples of such services include e-mail services provided by Microsoft (Hotmail/Outlook online), Google (Gmail) and Yahoo (Yahoo mail), productivity applications such as Microsoft Office 365 and Google Docs, and Web service platforms such as Amazon Web Services (AWS) and Elastic Compute Cloud (EC2) and Microsoft Azure. Cloud-hosted services are typically implemented using data centers that have a very large number of compute resources, implemented in racks of various types of servers, such as blade servers filled with server blades and/or modules and other types of server configurations (e.g., 1U, 2U, and 4U servers).

A key measure for both server OEMs (Original Equipment Manufacturers) and CSPs (Cloud Service Providers) is Reliability, Availability, and Serviceability (RAS). While RAS was first used by IBM to define specifications for its mainframes and originally applied to hardware, in today's data centers RAS also applies to software and networks.

Server OEMs and CSPs have continually indicated that hardware RAS handling needs to continue to improve on system resilience. In today's virtualized environments, multiple virtual machines (VMs) are run on platforms including host processors with multiple cores, with each VM hosting a set of one or more services (or applications/processes associated with such services). Optionally, container-based virtualization is also used, wherein one or more application runs in a virtualized container. The virtualized environments are run over platform hardware that needs to meet RAS requirements, such as specified in a Service Level Agreement (SLA).

In order to verify RAS SLA requirements are being met, data such as health information for memory and peripheral devices is generated and/or measured and logged. A portion of the health information is stored in machine specific registers (MSRs) and other locations that are not directly accessible by an operating system (OS) running on the platform. In order for the OS to access this information, the host processor first has to be put into System Management Mode (SMM) using a System Management Interrupt (SMI). An SMI interrupt service routine (ISR) or the like is run that reads the MSR and/or other data locations and returns the information to the operating system. This reduces system performance, as entering and exiting SMM results in significant overhead and the processor core cannot be used for processing application workloads while in SMM.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of a high-level architecture illustrating an overview of one embodiment of a PMC-based RAS solution, according to one embodiment;

FIG. 2 is a schematic diagram illustrating a first exemplary implementation of a processor and platform RAS solution using a PMC communicatively couple to a processor, according to one embodiment;

FIG. 2a is a schematic diagram illustrating a second exemplary implementation of a processor and platform RAS solution using a PMC that is embedded on a processor, according to one embodiment;

FIG. 3 shows a flowchart illustrating operations for accessing processor and platform RAS data via a PMC, according to one embodiment;

FIG. 4 shows a flowchart illustrating operations for accessing processor and platform RAS data via a PMC using a RAS event-driven model, according to one embodiment;

FIGS. 5a-5c are schematic diagrams illustrating alternative configurations for implementing PMC functionality, wherein the configuration of FIG. 5a includes a baseboard management controller (BMC) connected to an IO hub that is connected to a processor, the configuration of FIG. 5b shows a manageability engine and an innovation engine connected to the IO hub, and the configuration of FIG. 5c shows the manageability engine and innovation engine connected to IO interfaces on the processor;

FIG. 6 is a schematic diagram illustrating a software architecture based on a type-1 hypervisor in accordance with the “Xen” architecture;

FIG. 7 shows a software architecture corresponding to a container-based implementation environment in which applications are run in containers;

FIG. 8 is a high-level block architecture illustrating mechanisms for accessing a BIOS MMIO mailbox, an SMM MMIO mailbox, and an OS MMIO mailbox;

FIG. 9 is a diagram illustrating a mailbox input register and a mailbox output register, according to one embodiment;

FIG. 9a is a diagram illustrating alternative formats for the mailbox input register and mailbox output register under which pointers are used; and

FIG. 10 is a logic flow diagram illustrating operations performed in accordance with one embodiment of a BIOS/SMM mailbox flow and a PMC firmware and mailbox firmware flow.

### DETAILED DESCRIPTION

Embodiments of management controller solutions for processor and platform RAS and associated methods, apparatus, and software are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments disclosed herein, solutions are provided to address the shortcomings of existing RAS schemes. Under one embodiment, a platform management controller (PMC) performs SMI-like functionality including reading SMART (Self-Monitoring, Analysis and Reporting Technology) data from memory devices and storage devices, translating operating system visible systems physical addresses to memory DIMM (Dual In-line Memory Module) address, and obtaining other RAS-related data using out-of-band mechanisms that do not require the processor to service SMIs.

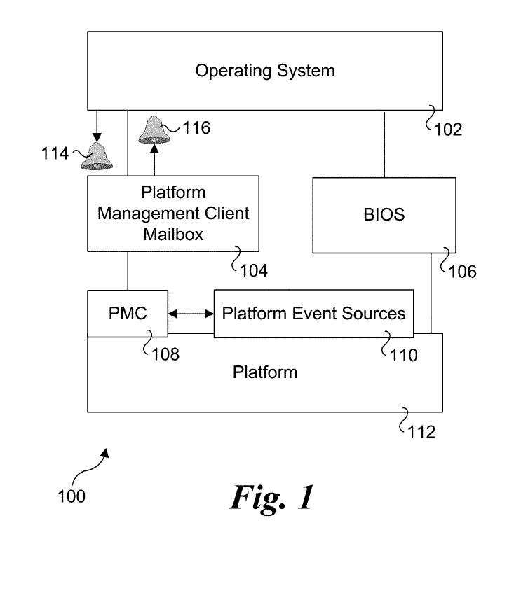

A high-level architecture 100 illustrating an overview of one embodiment of a PMC-based RAS solution is shown in FIG. 1. Architecture 100 includes an operating system 102, a platform management client mailbox 104, Basic Input-Output System (BIOS) 106, a PMC 108, platform event sources 110, and a platform 112. During run-time operations, various platform resources generate platform events, as depicted by platform event sources 110. These events are monitored by PMC 108 using a push notification and/or pulling scheme(s). Platform management client mailbox 104 is accessed by both operating system 102 and PMC 108. As illustrated, in one embodiment, operating system uses a “doorbell ring” 114 to ring platform management client mailbox 104. Meanwhile, PMC implements a listener for platform management client mailbox 104 and detects the doorbell ring. In response, PMC forwards platform event data and/or other RAS-related data gathered from platform 112 to platform management client mailbox 104, optionally sending a doorbell ring 116 to operating system 102. Operating system 102 then accesses the platform event data and/or other RAS-related data.

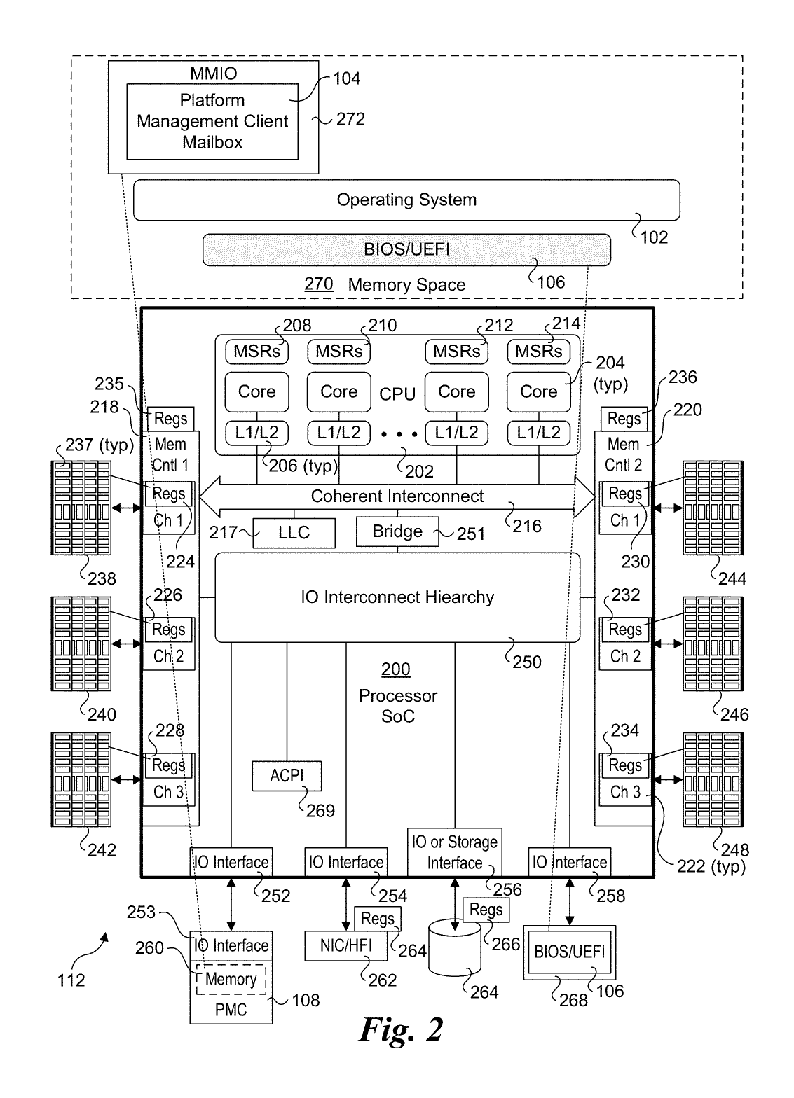

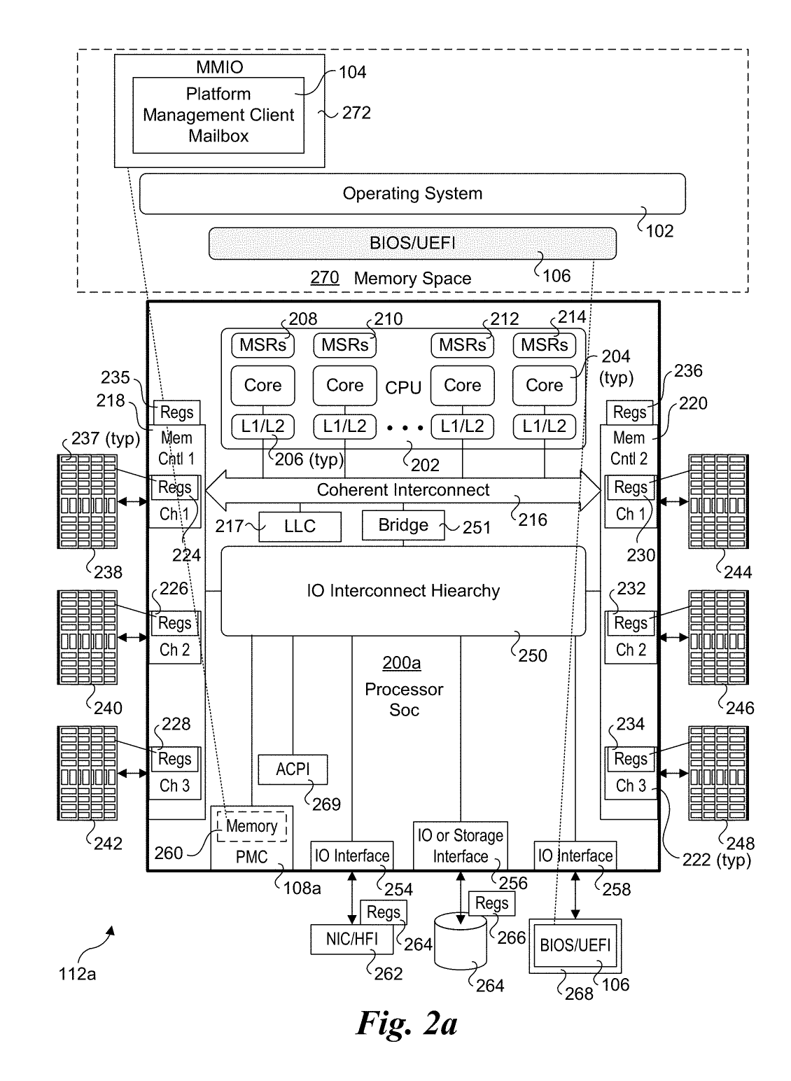

An exemplary implementation of a processor and platform RAS solution using a PMC is shown in FIG. 2. Platform 112 includes a processor 200 having a System on a Chip (SoC) architecture. This includes a central processing unit (CPU) 202 including a plurality of processor cores 204. Each processor core is coupled to a Level 1 and Level 2 (L1 and L2) cache 206 and includes one or more machine specific registers (MSRs), as depicted by MSRs 208, 210, 212, and 214.

Process cores 204 and their L1/L2 caches 206 are connected to a coherent interconnect 216 to which a Last Level Cache (LLC or L3 cache) 217 is also connected. Coherent interconnect 216 is also connected to two memory controllers 218 and 220, each with three memory channels 222. In the illustrated embodiment, each memory channel has a set of one or more registers (Regs), as depicted by registers 224, 226, 228, 230, 232, and 234. Optionally or in addition to, the memory controllers 218 and 220 may include a respective set of registers that is used for each memory controller, as depicted by registers 235 and 236.

One or more DIMMs 237 are connected to each memory channel 222, as depicted by sets of DIMMs 238, 240, 242, 244, 246, and 248. Current enterprise/cloud computer systems have volatile memory, for example DRAM (Dynamic Random Access Memory) memory, and storage class non-volatile memory such as 3D crosspoint (3D XPOINT™) technology DIMMs (Dual In-line Memory Modules), which are populated locally within the compute node. Other types of memory may also be used.

Non-volatile memory is a storage medium that does not require power to maintain the state of data stored by the medium. Non-limiting examples of nonvolatile memory may include any or a combination of: solid state memory (such as planar or 3D NAND flash memory or NOR flash memory), 3D crosspoint memory, storage devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), other various types of non-volatile random access memories (RAMs), and magnetic storage memory. In some embodiments, 3D crosspoint memory may comprise a transistor-less stackable cross point architecture in which memory cells sit at the intersection of words lines and bit lines and are individually addressable and in which bit storage is based on a change in bulk resistance. In particular embodiments, a memory module with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at www.jedec.org).

Volatile memory is a storage medium that requires power to maintain the state of data stored by the medium. Examples of volatile memory may include various types of random access memory (RAM), such as dynamic random access memory (DRAM) or static random access memory (SRAM). One particular type of DRAM that may be used in a memory module 122 is synchronous dynamic random access memory (SDRAM). In particular embodiments, DRAM of the memory modules 122 complies with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at www.jedec.org). Such standards (and similar standards) may be referred to as DDR-based standards and communication interfaces of the storage devices 106 that implement such standards may be referred to as DDR-based interfaces.

Storage-class memory (SCM) combines the benefits of a solid-state memory, such as high performance and robustness, with the archival capabilities and low cost of conventional hard-disk magnetic storage. SCM is a new hybrid storage/memory tier with unique characteristics. It's not exactly memory, and it's not exactly storage. Physically, it connects to memory slots in a motherboard, like traditional DRAM. While SCM is slightly slower than DRAM, it is persistent, meaning that, like traditional storage, its content is preserved during a power cycle. Compared to flash, SCM is orders of magnitude faster, providing performance gains on both read and write operations. It has another benefit over flash as well—SCM tiers are significantly more resilient, not suffering from the wear that flash falls victim to.

Generally, SCM can be addressed at either the byte or block level, depending on the particular implementation. This gives operating systems, software and hypervisor developers significant flexibility regarding the medium's applications. For example, it's conceivable that operating systems will initially treat SCM as block storage devices formatted by file systems and databases for compatibility purposes. However, next-generation applications may choose to access SCM directly via memory-mapped files using byte-level addressing. Hypervisors can abstract and present isolated SCM regions directly to different VMs as either execution memory or a flash-like storage resource. In one embodiment, sets of DIMMs 238, 240, 242, 244, 246, and 248 are SCM memories comprising 3D crosspoint DIMMs.

An IO hierarchy 250 is connected to coherent interconnect 250. In one embodiment, coherent interconnect employs a first protocol, while IO hierarchy 250 employs a second protocol, and there is a bridge 251 that is used to perform protocol translation and interface operations between these interconnects. IO interconnect hierarchy is connected to IO interfaces 252, 254, and 258, and an IO or storage interface 256.

It will understood that IO interfaces and IO interconnect hierarchy are illustrative of various types of IO interfaces and IO interconnect hierarchies that may employ one or more protocols and employ one or more difference types of physical interfaces and links. Moreover in implementations employing different types of physical interfaces and links, appropriate bridges will be implemented (not shown). In one embodiment, IO interconnect hierarchy is a Peripheral Component Interconnect Express (PCIe) interconnect hierarchy including a PCIe root controller coupled to PCIe root ports.

IO interface 252 is coupled to PMC 108 via an IO interface 253. In the illustrated embodiment, PMC 108 includes on-board memory 260, which is optional. A PMC may also include one or more sets of registers (not shown). As the controller aspect of its name implies, in one embodiment PMC 108 includes embedded logic, such as a microcontroller or other processing element(s) that execute instructions to implement the functionality of the PMCs described herein. Generally, IO interfaces 252 and 253 may comprise one or more types of IO interfaces and associated protocols, including but not limited to PCIe, RapidIO, GenZ, Fibre Channel, USB (Universal Serial Bus), InfiniBand, and HyperTransport.

IO interface 254 is connected to a network interface controller (NIC) or host fabric interface (HFI) 262 including a set of one or more registers 264. When platform 112 is installed in a rack in a datacenter, NIC/HFI 262 is connected to a network or fabric (not shown). For example, if the network is an Ethernet network, NIC/HFI 262 may comprise an Ethernet NIC. Optionally, if NIC/HFI 262 is connected to a fabric, than NIC/HFI 262 may comprise an HFI that is configured to interface with the fabric.

IO or storage interface 256 is coupled to one or more storage devices 264 including a set of one or more registers 266. In one embodiment, IO or storage interface 256 comprises a storage device controller that includes a set of one or more registers (not shown). In one embodiment, IO or Storage interface is a PCIe interface that is coupled to a PCIe storage device. Other types of storage device interfaces and/or controllers may also be used.

A BIOS or firmware storage device 268 is coupled to IO interface 258. BIOS is generally a generic term for BIOS and/or firmware that is implemented on a platform. For historical reasons the term “BIOS” is used, while today's firmware is much more sophisticated than the BIOS found in personal computers (PCs) in the 1980's and 1990's. In one embodiment, the platform firmware comprises Universal Extensible Firmware Interface (UEFI) firmware, which has provisions for support extensible firmware was associated functionality. Accordingly, in FIG. 2 the platform firmware is depicted as BIOS/UEFI 106.

During platform initialization operations, the physical memory addresses of DIMMs 238, 240, 242, 244, 246, and 248 is mapped into a virtual address space 270. The platform will employ applicable mechanisms for mapping between virtual memory and physical memory address using schemes that are well-known in the art. These may include use of hardware and/or software components.

A platform may include an ACPI component to facilitated ACPI-related operations including include ACPI operations facilitated via ASL code. In the embodiment of FIG. 2, and ACPI block 269 is implement in processor 200. Optionally, an ACPI component may be coupled to processor 200 via an appropriate interface (both not shown).

Prior to loading operating system 102 into memory space 270, BIOS/UEFI 106 will be loaded into memory space 270. Under UEFI, a first portion of the platform firmware is loaded into a protected area of the memory space and executed, wherein execution of the firmware causes the extensible portions of the firmware to be loaded into memory space 270 or otherwise configured to be executed during subsequent run-time operations.

Generally, platform management client mailbox 104 may be implemented in memory space 270, or may be implemented elsewhere on the platform (not shown). In the illustrated embodiment, platform management client mailbox is physically implemented in on-board memory 260 on PMC 108, and a Memory Mapped IO (MMIO) mechanism is used that maps the physical address space for PMC 108 into a MMIO region 272 of memory space 270. Under the MMIO approach, the operating system employs memory reads and writes using virtual memory addresses associated with MMIO region 272; meanwhile, these virtual addresses are translated to the physical addresses on the MMIO device, which in this case is memory 260. In one embodiment a Direct Memory Access (DMA) scheme is used that facilitates transfer of data from memory 260 to MMIO region 272.

In addition to having a PMC implemented in a component that is communicatively coupled to a processor, the functionality of the PMCs described herein may be implemented via embedded circuitry in the processor itself. For example, an exemplary embodiment of a computing platform 112a including a processor SoC 200a having an integrated PMC 108a is shown in FIG. 2a. Generally, PMCs 108 and 108 in the embodiments of FIGS. 2 and 2a operate in a similar manner, except that PMC 108a is integrated on the processor.

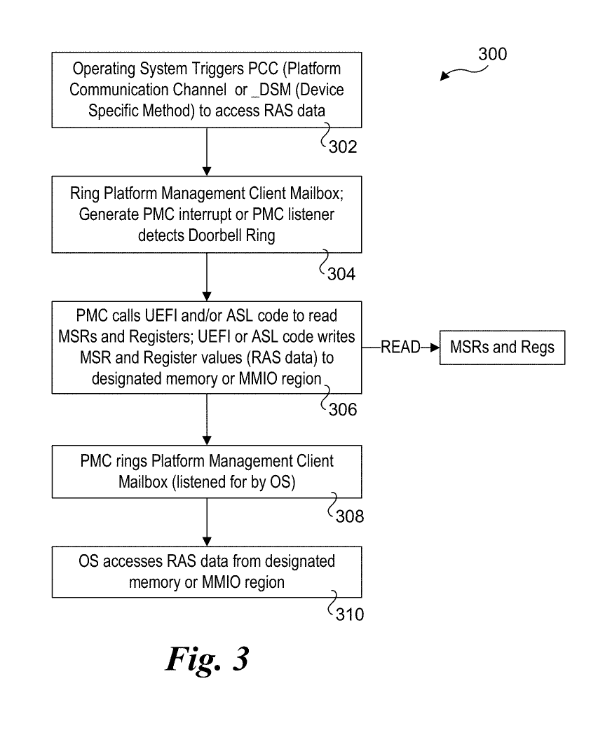

FIG. 3 shows a flowchart 300 illustrating operations for accessing processor and platform RAS data via a PMC, according to one embodiment. In a block 302, the operating system triggers a PCC (Platform Communication Channel) or _DSM (Device Specific Method to access RAS data. For example, the _DSM may use ACPI (Advanced Configuration and Power Interface) source language (ASL) to access certain registers or MSRs containing the RAS data to be accessed. Other _DSMs may employ platform firmware, such as UEFI firmware associated with a particular processor or platform component. In one embodiment, a PCC is opened (if not previously opened) to enable communication with the PCM and/or to access the platform management client.

Next, in a block 304 a message or the like is sent to the platform management client mailbox to effect a doorbell ring. In response to receiving the message, the platform management client mailbox invokes an interrupt of the PMC, under one embodiment. In another embodiment, the PMC is configured to “listen” for doorbell rings of the platform management client mailbox, such as using periodic polling or other listening methods. Under either of the interrupt or listening techniques, the PMC is informed of the doorbell ring.

In a block 306 the PMC calls UEFI or ASL code to read MSRs and/or registers to service the interrupt or in response to a detected doorbell ring. In one aspect, the UEFI or ASL code is privileged code that runs in a secure mode that enables access to MSRs and/or registers that would normally be accessed while the processor was in SMM. However, since the UEFI or ASL code is being called from the PMC and not invoked via an SMI, access to the MSRs and/or registers is performed “out-of-band” (00B), meaning it is done without consuming CPU cycles (i.e., does not consume any of the processor core cycles in the CPU). Thus, the processor cores can continue executing their workloads without being interrupted.

The UEFI or ASL code that is being called retrieves RAS data from applicable MSRs and/or registers by reading them and then writing the data values to one of designated memory or a MMIO region. Examples of designated memory include memory on-board the PMC, memory or registers in the processor, or memory in a device attached to the processor other than the PMC. As discussed above, if the PMC's on-board memory is mapped into the platform's system address space using MMIO, and writing of data to this PMC memory will be copied into the MMIO region in the system address space.

Let's consider a few non-limiting examples, with reference to FIG. 2. In one embodiment, the PMC is enabled to access MSRs 208, 210, 212, and 214 in CPU 202 via a UEFI call. In another embodiment, SMART data associated with storage devices and 3D crosspoint DIMMs is accessed from one or more of registers 224, 226, 228, 244, 246, 248, and 266. If conventional DRAM memory is employed by the platform, data indicating the health of the DRAM DIMMs may likewise be accessed via one or more of registers 224, 226, 228, 244, 246, 248. Optionally, memory health information may be accessed by registers 235 and 236.

Use of ASL code may be used to access RAS data relating to the platform's ACPI support. While ASL code may be called directly by an operating system today, the OS will have to wait for the ASL method to be completed, which consumes CPU cycles. For example, the ASL method may return ACPI data, which will need to be read from ACPI registers or otherwise accessed via ACPI facilities on the platform on in the processor. Under the embodiment of flowchart 300, an ASL call sent to the platform management client mailbox is returned substantially immediately (such as a return confirming the doorbell has been rung). However rather than return and ACPI data, this call is merely a request for the PCM to get the data and write it to a location in memory that can be subsequently accessed by the operating system.

After the UEFI and/or ASL code in block 306 has been executed and the RAS data has been written to the designated memory or MMIO region, the PMC rings the platform management client mailbox in a block 308. In one embodiment, the operating system implements a listener to listen for platform management client mailbox doorbell rings. Optionally, another mechanism may be used to detect the doorbell ring.

The doorbell ring is used to inform the operating system that the RAS data is ready to access. Accordingly, in a block 310 the operating system access the RAS data from the designated memory or MMIO region to complete the process.

In addition to a doorbell scheme, the operating system may set up a channel (e.g., a Platform Communication Channel) directly with the PMC and submit RAS data requests directly to the PMC. For example, in one embodiment this would be analogous to a remote procedure call commonly used in distributed systems, except rather than using separate platforms, the remote entity would be the PMC on the same platform, which would execute the procedure call passed to it (by retrieving the RAS data from the MSR and/or registers), and return the data to the operating system, either in a message or as a pointer to a location at which the data can be read by the operating system.

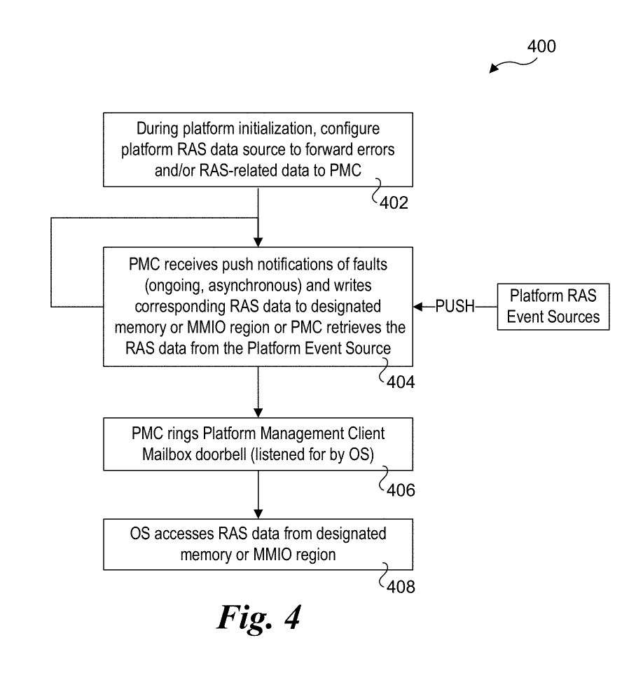

In addition to retrieving RAS data and making it available to an operating system in response to requests initiated by the operating system, a platform may be configured to capture RAS event data, forward or write the RAS event data an accessible memory location or region, and then inform the operating system of its availability. Operations associated with one embodiment of this approach are illustrated in flowchart 400 of FIG. 4. The process begins in a block 402 in which during platform initialization, platform RAS data sources are configured to forward errors and/or RAS-related data to the PMC. For example, certain types of devices and processor components may be configured, during execution of the platform firmware, to write errors to a predetermined memory address or register that is either associated with the PMC or may be accessible to the PMC.

Once the initial configuration is performed in block 402, ongoing operations are performed during run-time, as depicted by a block 404. During these ongoing run-time operations, platform RAS sources may detect errors and “push” either a notification of the error or data relating to the error to the PMC. These are referred to herein as push notifications. The push notification itself may write the data to a predetermined location, such as a location in the PMC's on-board memory. Optionally, the push notification simply identifies the platform component providing the notification and in response to receiving the notification the PMC retrieves the RAS data relating to the event from the platform component.

In a block 406, the PMC rings the platform management client mailbox doorbell, which is listened to be the operating system or otherwise detected by the operating system through another mechanism. Generally, the PMC may ring the doorbell in response to individual platform RAS events, platform RAS events having a predetermined significance level or category, or on a periodic basis. The OS then access the RAS data from the designated memory or MMIO region, as before.

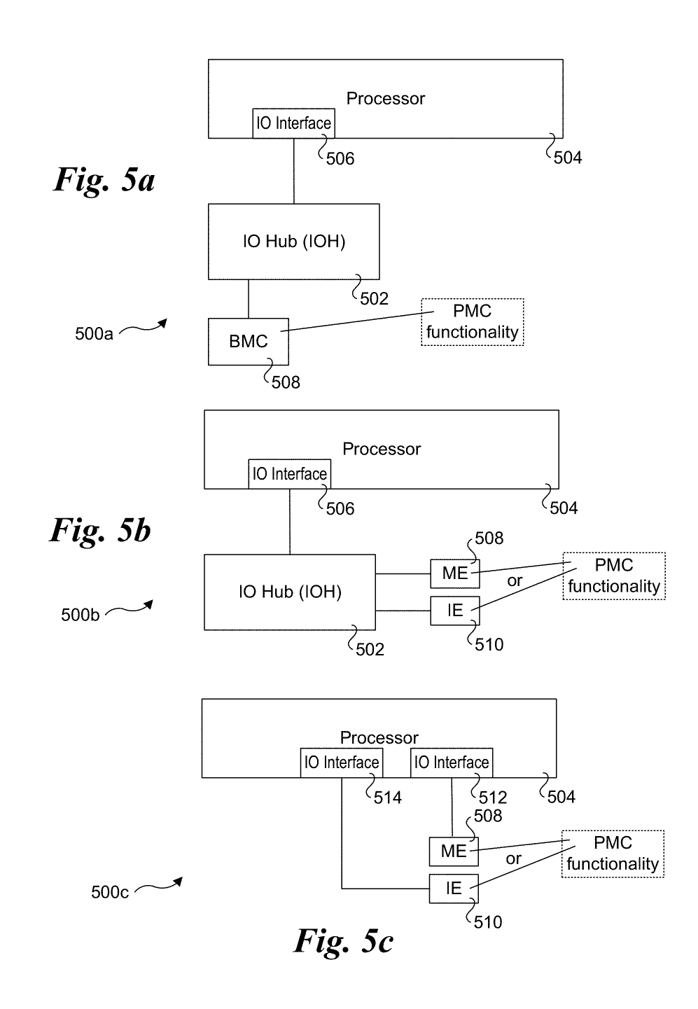

In addition to the configurations illustrated in FIGS. 2 and 2a, the functionality for a PMC described herein may be implemented in other platform components. Non-limiting examples of such components and associated platform configurations 500a, 500b, and 500c are respectively shown in FIGS. 5a, 5b, and 5c.

In configuration 500 of FIGS. 5a, an IO hub (IOH) 502 is coupled to a processor 504 via an IO interface 506. A baseboard management controller (BMC) 508 is coupled to IOH 502. The PMC functionality is implemented in BMC 508, which is enabled to communicate with components in processor 504 and attached to processor 504 (not shown) via IOH 502 and IO interface 506. In one embodiment, IOH 502 is a platform controller hub (PCH).

In configuration 500b, the PMC functionality is implement in one of a manageability engine (ME) 508 or an innovation engine (IE) 510 that are coupled to IOH 502. In one embodiment ME 508 is implemented as a converged security and manageability engine (CSME). In some embodiments, original equipment manufacturers (OEMs) may want to deploy customized functionality to augment the facilities provided by ME 508. These may be implemented by IE 510, which is also referred to as an OEM innovation engine. Generally, the use of IE 510 is optional.

As with configuration 500b, in configuration 500c the PMC functionality is implement in ME 508 or IE 510. In this configuration, a IOH is not use, with ME being connected to processor 504 via an IO interface 512 and IE 510 being connected to processor 504 via an IO interface 514.

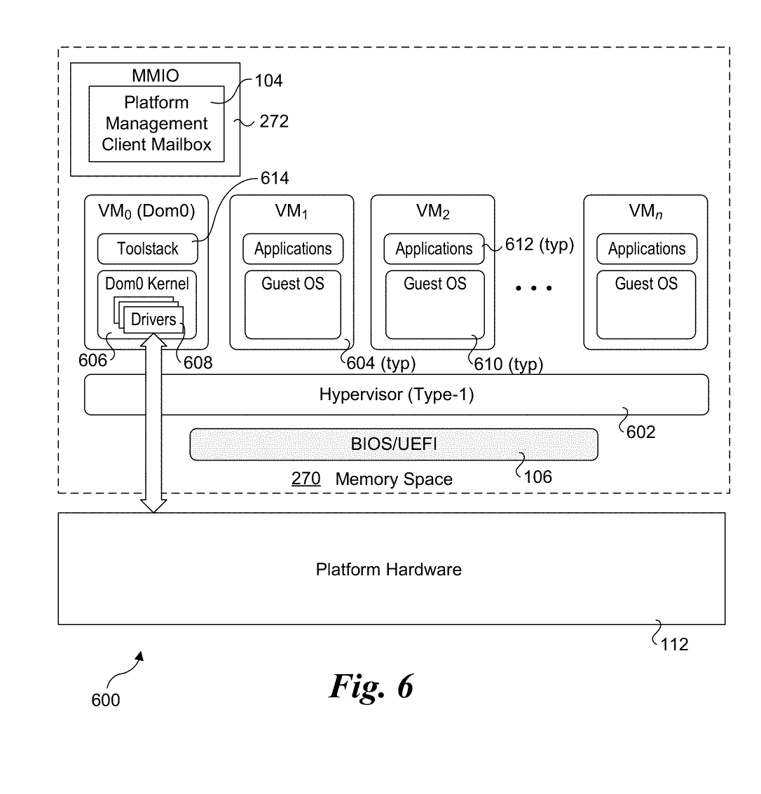

In addition to the software architectures shown in the memory spaces of FIGS. 2 and 2a, other type of software architectures including virtualized software architectures may be implemented. For example, FIG. 6 shows a software architecture 600 including a type-1 hypervisor and having a configuration in accordance with the “Xen” open-source project architecture. As shown, software architecture 600 includes a type-1 hypervisor 602 that is used to host a plurality of virtual machines (VMs) 604, labeled VM₀-VMₙ. Under the Xen architecture the first VM₀, which is referred to as Dom0 (domain 0), includes a Dom0 kernel 606 including drivers 608. Meanwhile, the other VMs VM₀-VMₙ host a respective guest OS 610 used to run applications 612.

In one embodiment, software code or a software component in Dom0 kernel 606 performs the operating system functions illustrated in FIGS. 1, 2, and 2a and described in flowcharts 300 and 400 of FIGS. 3 and 4. Optionally, software code or a software component depicted as toolstack 614 is used to perform these operating system functions.

Other embodiments support container-based software execution environments, under which applications are executed in containers. The use of container-based execution environments has recently seen widespread adoption in data centers, such as containers based on DOCKER™. (It is noted that other container-based implementation that do not use DOCKER™ may also be deployed.)

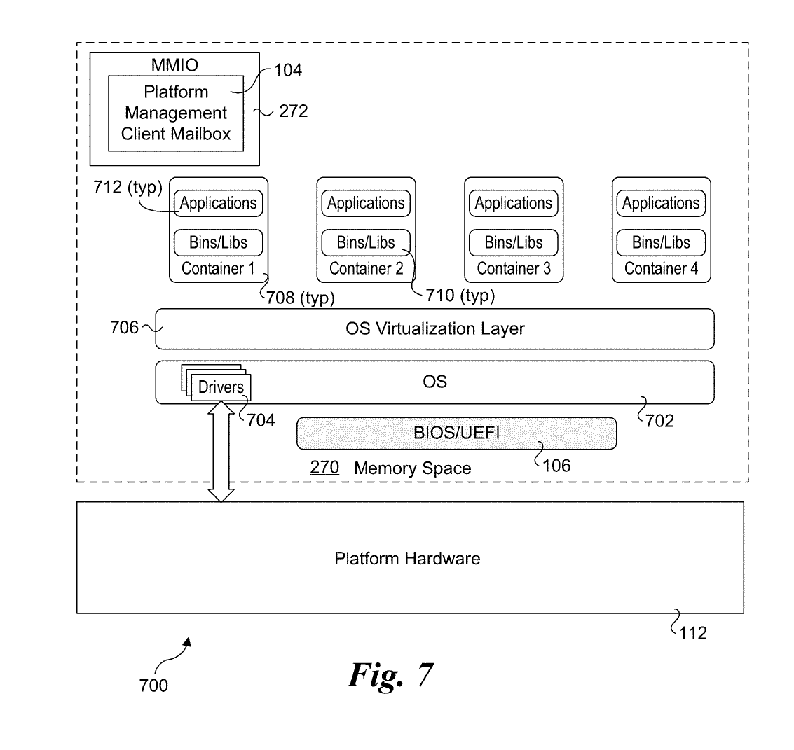

An exemplary container-based software execution environment is shown in software architecture 700 of FIG. 7. Software architecture 700, includes an operating system 702 including drivers 704 that enable OS 702 to interface with platform hardware 112. OS 702 may also interact with platform hardware 112 via BIOS/UEFI firmware 106. An OS virtualization layer 706 is disposed above OS 702. Under DOCKER™ terminology this is called the DOCKER™ engine. The OS virtualization layer, in combination with the operating system, is used to host multiple containers 708. Each container includes a set of binary executables and libraries (Binaries/Libraries) 710 that is used to facilitate execution of one or more applications 712 within the container.

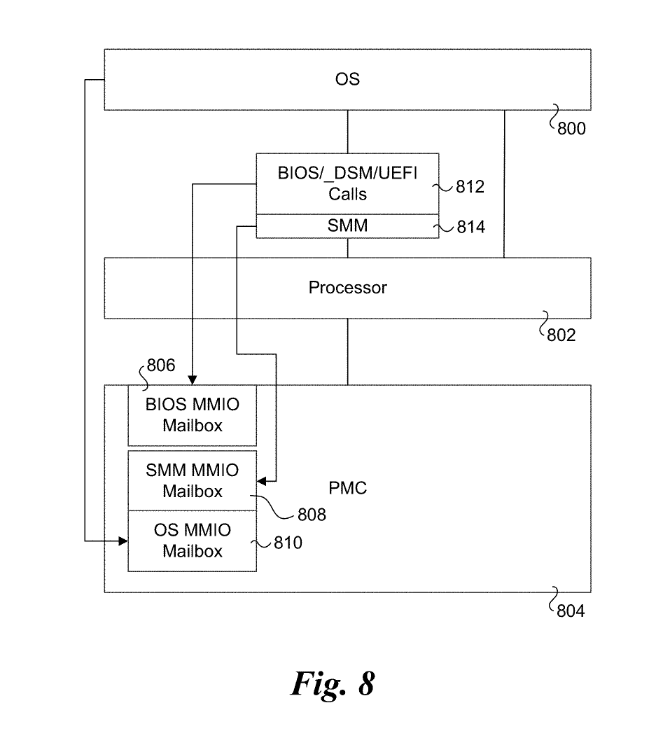

Further aspects of the mailbox operation, according to exemplary embodiments, are shown in FIGS. 8-10. FIG. 8 shows a high-level block architecture including an OS 800 running on a processor 802 that is connected to a PMC 804. In respective embodiments, processor 802 generally has a configuration corresponding to the processor SoC 200 and 200a shown in FIGS. 2 and 2a and described above. PMC 804 generally may be implemented as a separate components, as shown in FIG. 2, or as an on-chip (on the SoC) component, as shown in FIG. 2a.

PMC 804 includes a BIOS MMIO mailbox 806, an SMM MMIO mailbox 808, and an OS MMIO mailbox 810. For simplicity, on a single instance of each mailbox is shown in FIG. 8, while in practice there may be one or more instances of these mailboxes. BIOS MMIO mailbox 806 is accessed via BIOS, _DSM, and/or UEFI calls 812. SMM MMIO mailbox 808 is accessed by SMM 814, implying that is may only be accessed by processor 802 when processor 802 is operating in System Management Mode.

As further shown in FIG. 8, OS MMIO mailbox 810 is accessed by OS 800. However, OS MMIO mailbox 810 can also be accessed by other entities besides the OS. For example, in some embodiments, all or a portion of the RAS data that is collected by various entities described herein is written to OS MMIO Mailbox such that it can be subsequently accessed by the OS. As described below, mailbox input and output registers in the various MMIO mailboxes, including OS MMIO Mailbox 810, may implement pointers to where various data are stored, including collected RAS data.

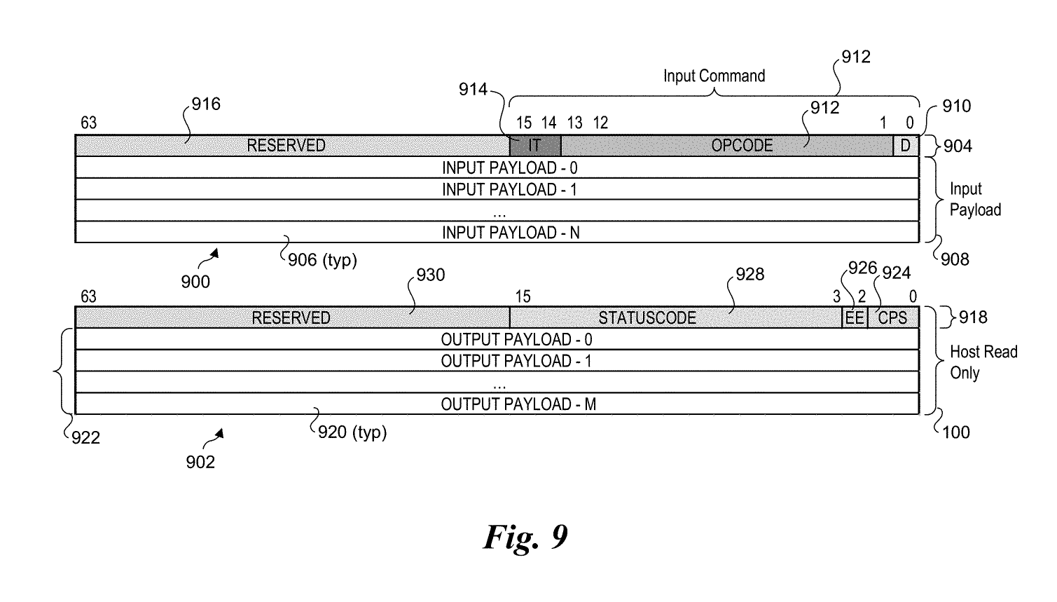

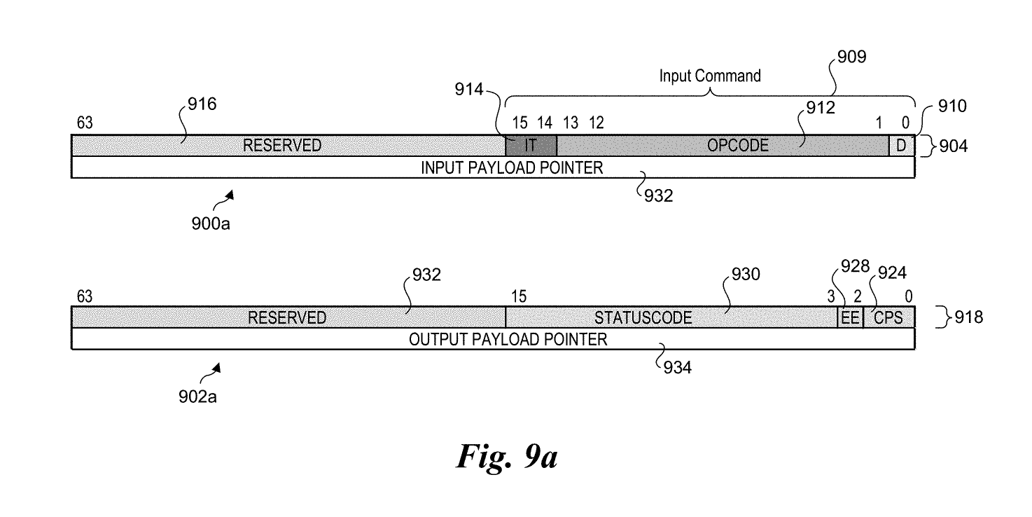

FIG. 9 illustrated embodiments of a mailbox input register 900 and mailbox output register 902. Each of BIOS MMIO mailbox 806, SMM MMIO mailbox 808, and OS MMIO mailbox 810 includes multiple instances of mailbox input register 900 and mailbox output register 902. Rather than hardware-type registers, each of mailbox input register 900 and mailbox output register 902 is a logical register occupying a portion of the MMIO address space associated with PMC 804.

In the illustrated embodiment, mailbox input register 900 includes a 64-bit header 904 and one or more 64-bit input payload fields 906 comprising the input payload 908. Header 904 includes an input command 909 comprising a Doorbell (‘D’) flag 910, an OPCODE field 912, and an ‘IT’ (Interrupt mechanism) field 914. When the host sets the Doorbell ‘D’ flag 910, the PMC generates an internal interrupt to process the input. Optionally, a polling process may be implemented rather than an internal interrupt. In one embodiment, the host writes input payload 908, and when the Doorbell bit is set, the input payload is host write-protected.

OPCODE field 912 includes an OpCode (Operational Code) that defines the function number. A subset of the function are used for establishing encryption keys. In the illustrated embodiment, the ‘IT’ field 914 is a 2-bit field storing a value used to identify what interrupt on command completion mechanism should be used. Generally, the platform design can decide whether to use SMI/SCI or other interrupts mechanisms. The upper 48 bits of header 904 are reserved, as depicted by a RESERVED field 916.

It is noted that the size of the fields in header 904 are merely illustrative of one example configuration. Generally, the size of the fields may vary depending on the particular implementation the/or the functionality that is to be supported. For example, if the number of OpCodes is small, the input command could be a single byte.

Mailbox output register 902 includes a 64-bit header 918 and one or more 64-bit output payload fields 920 comprising the output payload 922. Header 918 includes a Command Process Status (‘CPS’) field 924, an Encryption Enabled (‘EE’) flag 926, a STATUSCODE field 928, and a RESERVED field 930. In one embodiment, a mailbox output register 902 is a host read-only register, meaning the host can read a mailbox output register, but cannot write to it.

CPS field 924 is a 2-bit field that stores the command progress status. In one embodiment, a new command can be completed only when the CPS identifies it is completed. In one embodiment of a special case, the CPS field could be used to abort the current command Opcode. EE flag 926 is a single bit that is used to flag (i.e., indicate) whether or not encryption is enabled. STATUSCODE field 928 is used to store a status code that indicates success if the value is ‘0’ or it has certain bit patterns and/or error codes to indicate corresponding results.

FIG. 9a shows an alternative format of a mailbox input register 900a and a mailbox output register 902a under which pointers are used. Generally, the headers 904 and 918 are the same as for mailbox input register 900 and a mailbox output register 902 of FIG. 9. However, rather than including the input and output payload data in the registers, pointers to the locations of the input and output payloads (which are stored elsewhere) are provided. These pointers are depicted as an input payload pointer 932 and an output payload pointer 934. As a variant, the input and output payload pointers could be stored in RESERVED fields 916 and 932, and a 32-bit addressing scheme could be used. (It is noted that a 32-bit addressing scheme could also be used with input payload pointer 932 and output payload pointer 934.

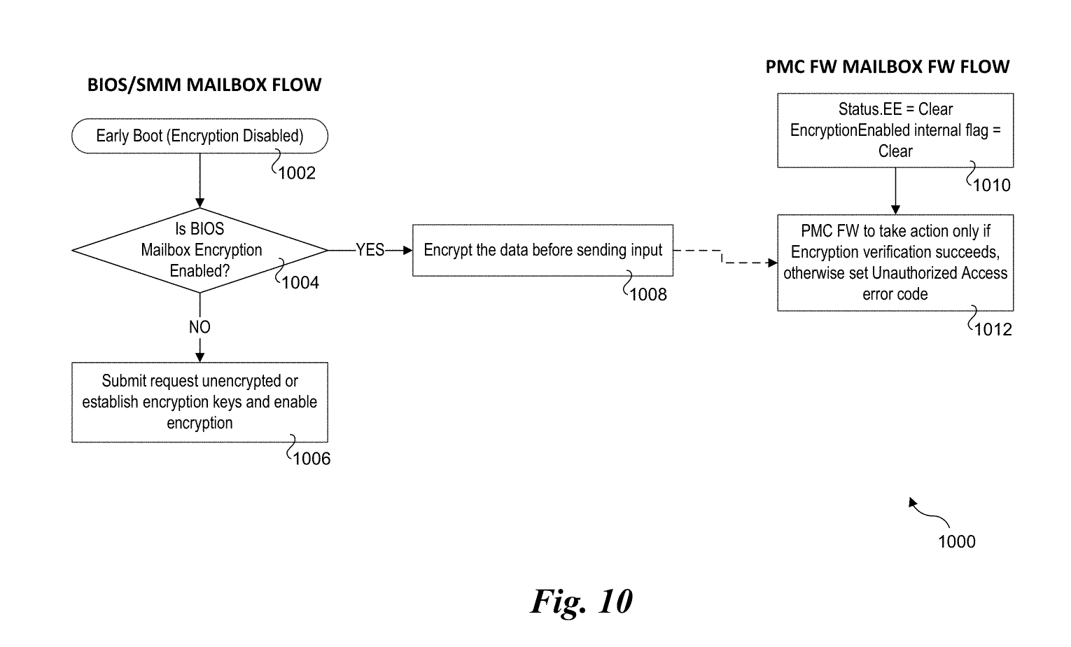

FIG. 10 illustrated a logic flow diagram 1000 illustrating operations performed in accordance with one embodiment of a BIOS/SMM mailbox flow and a PMC firmware and mailbox firmware flow. As depicted in a start block 1002, during early boot encryption is disabled. In a decision block 1004, a determination is made to whether BIOS mailbox encryption is enabled. If the answer is NO, the logic proceeds to a block 1006 in which an unencrypted request is submitted or encryption keys are established to enable encryption.

In a block 1010 of the PMC firmware and mailbox firmware flow, the EE (encryption enabled) flag if cleared. If the answer to decision block 1004 of the BIOS/SMM mailbox flow is YES, the data is encrypted before sending the input to the PMC mailbox. In a block 1012, the PMC firmware will only take action if encryption verification succeeds, otherwise an Unauthorized Access error code is set.

In one embodiment, the EE flag is set if encryption or password/passphrase do not match, without affecting other bits (hence it is unauthorized access). If an authorized command is submitted, then the EE flag will be clear. In one embodiment, other bits and payloads are valid only when the EE flag is clear.

Generally, software components that are used to access processor and platform RAS data via the platform management client mailbox may be implemented in the OS, the OS virtualization layer, or in one of the containers. However, in each of these implementations, the communication with the platform management client mailbox is ultimately facilitated by the operating system, thus, in the description herein, including the claims, an operating system is referred to as accessing the RAS data (in conjunction with collection operations by a PMC) or otherwise ringing the doorbell of and/or detecting a doorbell has been rung for the platform management client mailbox.

The embodiments of the management controller solutions for processor and platform RAS disclosed herein provide advantages over current conventional approaches. Since the access to the RAS data is performed using out-of-band mechanism that do not require the system to be put into SMM, the acquisition of RAS data is facilitated in a manner with minimal overhead (with respect to consuming CPU cycles). The support for both push and pull models supports both event-driven implementations, as well as OS-driven RAS data collection schemes. The use of a platform management client mailbox and associated doorbells also provides a communication channel and asynchronous notification mechanism to enable RAS data to be collected in response to OS requests, as well as push RAS event data to the OS.

Further aspects of the subject matter described herein are set out in the following numbered clauses:

1. A method performed by a computing platform including a processor coupled to at least one system memory device, a platform management controller (PMC), and a plurality of Reliability, Availability, and Serviceability (RAS) data sources, the method comprising:
collecting RAS data from at least a portion of the plurality of RAS data sources using the PMC; and
enabling an operating system running on the computing platform to access the RAS data collected using the PMC.

2. The method of clause 1, further comprising:
receiving one of a notification or request from the operating system to provide RAS data to the operating system;
collecting the RAS data from the at least a portion of the plurality of RAS data sources using the PMC and writing the RAS data to memory, wherein the RAS data is written to a predetermined memory location in the memory that is accessible to the operating system.

3. The method of clause 2, wherein a notification comprising a doorbell ring is sent to a platform management client mailbox having a doorbell, the method further comprising:
one of invoking an interrupt of the PMC or detecting, via the PMC that the a doorbell of the platform management client mailbox has been rung; and
collecting the RAS data from the at least a portion of the plurality of RAS data sources using the PMC and writing the RAS data to memory in response to the doorbell ring.

4. The method of any of the preceding clauses, further comprising:
implementing a platform management client mailbox that is accessible to both the PMC and the operating system; and
ringing, via the PMC, a doorbell of the platform management client mailbox when the RAS data has been written to one of the predetermined location in the memory or the platform management mailbox.

5. The method of any of the preceding clauses, further comprising:
configuring at least one platform RAS data source to generate an RAS event in response to detecting a predetermined condition for a component associated with the RAS data source; and
during runtime operations of the computing platform, generating a RAS event,
receiving, at the PMC, one of a notification of the RAS event or RAS data corresponding to the RAS event.

6. The method of clause 1, wherein the platform includes one or more devices that generate SMART (Self-Monitoring, Analysis and Reporting Technology) data, and wherein collecting the RAS data includes collecting SMART data for at least one of the one or more devices that generate SMART data.

7. The method of any of the preceding clauses, wherein the processor includes a plurality of Machine Specific Registers (MSRs), and the RAS data that is collected includes RAS data read from at least one MSR.

8. The method of any of the preceding clauses, wherein the PMC includes on-board memory and the operating system runs in a virtual memory address space mapped to physical memory addresses in the at least one system memory device, further comprising:
mapping memory addresses in the on-board memory for the PMC into the virtual memory address space using Memory-Mapped Input Output (MMIO), creating a MMIO region in the virtual memory address space; and
implementing MMIO access for the on-board memory for the PMC,
wherein the operating system is enabled to read data in the on-board memory for the PMC using memory read requests to the MMIO region in the virtual memory address space.

9. The method of any of the preceding clauses, wherein the computing platform further includes Universal Extensible Firmware Interface (UEFI) firmware, and wherein at least a portion of the RAS data is collected via use of code in the UEFI firmware.

10. The method of any of the preceding clauses, wherein the computing platform includes a RAS data source relating to an Advanced Configuration and Power Interface (ACPI) function, and wherein RAS data is collected from the RAS data source using ACPI source language (ASL) code.

11. The method of any of the preceding clauses, wherein the PMC comprises circuitry that is integrated on the processor.

12. A computing platform, comprising:
a processor, including one or more memory controllers;
for each of the memory controllers, one or more system memory device coupled to that memory controller;
a platform management controller (PMC), either communicatively coupled to the processor or integrated on the processor,
a firmware device, coupled to the processor having system firmware installed therein;

and
a plurality of Reliability, Availability, and Serviceability (RAS) data sources, including at least one of,
RAS data sources on the processor; and
RAS data sources on components coupled to the processor,
wherein the platform is configured, upon operation, to,
host an operating system, the operating system either running on platform hardware or running in a virtual machine running on the platform;
map physical memory addresses for at least one system memory device to a virtual memory space in which an operating system is run,
collect RAS data from at least a portion of the plurality of RAS data sources using the PMC;
enable the operating system to access the RAS data collected by the PMC.

13. The computing platform of clause 12, wherein the computing platform, upon operation, is further configured to:
receive one of a notification or request from the operating system to provide RAS data to the operating system;
collect the RAS data from the at least a portion of the plurality of RAS data sources using the PMC and writing the RAS data to memory on the platform, wherein the RAS data is written to a predetermined memory location in the memory that is accessible to the operating system.

14. The computing platform of clause 13, wherein a notification comprising a doorbell ring is sent to a platform management client mailbox having a doorbell, and wherein the computing platform, upon operation, is further configured to:
one of invoke an interrupt of the PMC or detect, via the PMC that the a doorbell of the platform management client mailbox has been rung; and, in response to the doorbell ring,
collect the RAS data from the at least a portion of the plurality of RAS data sources using the PMC and writing the RAS data to the memory that is accessible to the operating system.

15. The computing platform of any of clauses 12-14, wherein the computing platform, upon operation, is further configured to:
implement a platform management client mailbox that is accessible to both the PMC and the operating system; and
write RAS data collected by the PMC to memory on the platform, wherein the RAS data is written to a predetermined memory location in the memory that is accessible to the operating system; and
ring, via the PMC, a doorbell of the platform management client mailbox when the RAS data has been written to one of the predetermined location in the memory or the platform management mailbox.

16. The computing platform of any of clauses 12-15, wherein the computing platform, upon operation, is further configured to:
configure at least one platform RAS data source to generate a RAS event in response to detecting a predetermined condition for a component associated with the RAS data source; and
during runtime operations of the computing platform, generate a RAS event in response to detection of the predetermined condition; and
receive, at the PMC, one of a notification of the RAS event or RAS data corresponding to the RAS event.

17. The computing platform of any of clauses 12-16, wherein the platform includes one or more devices that generates SMART (Self-Monitoring, Analysis and Reporting Technology) data, and wherein collecting the RAS data includes collecting SMART data for at least one of the one or more devices that generate SMART data.

18. The computing platform of any of clauses 12-17, wherein the processor includes a plurality of Machine Specific Registers (MSRs), and the RAS data that is collected includes RAS data read from at least one MSR.

19. The computing platform of any of clauses 12-18, wherein the PMC includes on-board memory and the operating system runs in a virtual memory address space mapped to physical memory addresses in the at least one system memory device, and wherein the computing platform, upon operation, is further configured to:
map memory addresses in the on-board memory for the PMC into the virtual memory address space using Memory-Mapped Input Output (MMIO), creating a MMIO region in the virtual memory address space; and
implement MMIO access for the on-board memory for the PMC,
wherein the operating system is enabled to read data in the on-board memory for the PMC using memory read requests to the MMIO region in the virtual memory address space.

20. The computing platform of any of clauses 12-19, wherein the system firmware comprises Universal Extensible Firmware Interface (UEFI) firmware, and wherein at least a portion of the RAS data is collected via use of code in the UEFI firmware.

21. The computing platform of any of clauses 12-20, further comprising an Input-Output (IO) hub coupled between the PMC and the processor.

22. The computing platform of any of clauses 12-21, wherein the PMC comprises a baseboard manageability controller.

23. The computing platform of any of clauses 12-21, wherein the PMC comprises a manageability engine.

24. The computing platform of any of clauses 12-21, wherein the PMC comprises an innovation engine.

25. An apparatus comprising:
an input-output (IO) interface; and
on-board memory,
wherein the apparatus is configured to be communicatively coupled to a processor in a computing platform via the TO interface, the processor including one or more memory controllers to which one or more system memory devices are coupled, the computing platform having a plurality of Reliability, Availability, and Serviceability (RAS) data sources, including at least one of,
RAS data sources on the processor; and
RAS data sources on components coupled to the processor,
wherein the apparatus is configured to, when communicatively coupled to the processor and when the computing platform is operating, at least one of,
collect RAS data from one or more of the plurality of RAS data sources and store the RAS data that is collected in the on-board memory; and
receive RAS data relating to RAS events from one or more of the plurality of RAS data sources and store the RAS data that is received in the on-board memory.

26. The apparatus of clause 25, wherein the computing platform includes one or more devices that generate SMART (Self-Monitoring, Analysis and Reporting Technology) data, and wherein the RAS data includes SMART data collected or received from at least one of the one or more devices that generate SMART data.

27. The apparatus of clause 25 or 26, wherein the computing platform is further configured to implement a platform management client mailbox that is accessible to both an operating system running on the computing platform and the apparatus, the platform management client mailbox including a doorbell that is rung by the operating system, and wherein the apparatus is configured to one of detect that the doorbell of the platform management client mailbox has been rung by the operating system or receive an interrupt from the platform management client mailbox in response to the operating system ringing the doorbell of the platform management client mailbox.

28. The apparatus of any of clauses 25-27, wherein the computing platform is further configured to implement a platform management client mailbox that is accessible to both an operating system running on the computing platform and the apparatus, the platform management client mailbox including a doorbell, and wherein the apparatus is configured to ring the doorbell to inform the operating system that the apparatus has at least one of collected and received RAS data.

29. The apparatus of any of clauses 25-28, wherein the computing platform, when operating, hosts an operating system running in a virtual memory address space that includes a Memory-Mapped Input Output (MMIO) region in which physical addresses in the on-board memory are mapped to virtual addresses in the MMIO region, and wherein the operating system is enabled to read data stored in the on-board memory of the apparatus by using memory read requests to the MMIO region in the virtual memory address space.

30. The apparatus of any of clauses 25-29, wherein the apparatus is coupled to the processor via an Input-Output (IO) hub.

31. The apparatus of any of clauses 25-30, wherein the apparatus comprises a baseboard manageability controller.

32. The apparatus of any of clauses 25-30, wherein the apparatus comprises a manageability engine.

33. The apparatus of any of clauses 25-30, wherein the apparatus comprises an innovation engine.

34. An apparatus comprising:
an input-output (IO) interface; and
on-board memory,
wherein the apparatus is configured to be communicatively coupled to a processor in a computing platform via the IO interface, the processor including one or more memory controllers to which one or more system memory devices are coupled, the computing platform having a plurality of Reliability, Availability, and Serviceability (RAS) data sources, including at least one of,
RAS data sources on the processor; and
RAS data sources on components coupled to the processor,
wherein the apparatus further comprises at least one of,
means for collecting RAS data from one or more of the plurality of RAS data sources and store the RAS data that is collected in the on-board memory; and
means for receiving RAS data relating to RAS events from one or more of the plurality of RAS data sources and store the RAS data that is received in the on-board memory.

35. The apparatus of clause 34, wherein the computing platform includes one or more devices that generate SMART (Self-Monitoring, Analysis and Reporting Technology) data, and wherein the RAS data includes SMART data collected or received from at least one of the one or more devices that generate SMART data.

36. The apparatus of clause 34 or 35, wherein the computing platform is further configured to implement a platform management client mailbox that is accessible to both an operating system running on the computing platform and the apparatus, the platform management client mailbox including a doorbell that is rung by the operating system, and wherein the apparatus further includes means for detecting that the doorbell of the platform management client mailbox has been rung by the operating system or means for receiving an interrupt from the platform management client mailbox in response to the operating system ringing the doorbell of the platform management client mailbox.

37. The apparatus of any of clauses 34-36, wherein the computing platform is further configured to implement a platform management client mailbox that is accessible to both an operating system running on the computing platform and the apparatus, the platform management client mailbox including a doorbell, and wherein the apparatus further includes means for ringing the doorbell to inform the operating system that the apparatus has at least one of collected and received RAS data.

38. The apparatus of any of clauses 34-37, wherein the computing platform, when operating, hosts an operating system running in a virtual memory address space that includes a Memory-Mapped Input Output (MMIO) region in which physical addresses in the on-board memory are mapped to virtual addresses in the MMIO region, and wherein the operating system is enabled to read data stored in the on-board memory of the apparatus by using memory read requests to the MMIO region in the virtual memory address space.

39. The apparatus of any of clauses 34-38, wherein the apparatus is coupled to the processor via an Input-Output (IO) hub.

40. The apparatus of any of clauses 34-39, wherein the apparatus comprises a baseboard manageability controller.

41. The apparatus of any of clauses 34-39, wherein the apparatus comprises a manageability engine.

42. The apparatus of any of clauses 34-39, wherein the apparatus comprises an innovation engine.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a computer-readable or machine-readable non-transitory storage medium. A computer-readable or machine-readable non-transitory storage medium includes any mechanism for storing or transmitting information in a form readable by a machine (e.g., a computer). For example, a computer-readable or machine-readable non-transitory storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer-readable or machine-readable non-transitory storage medium may also include a storage or database from which content can be downloaded. The computer-readable or machine-readable non-transitory storage medium may also include a device or product having content stored thereon at a time of sale or delivery. Thus, delivering a device with stored content, or offering content for download over a communication medium may be understood as providing an article of manufacture comprising a computer-readable or machine-readable non-transitory storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including computer-readable or machine-readable non-transitory storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method performed by a computing platform including a processor coupled to at least one system memory device, a platform management controller (PMC), and a plurality of Reliability, Availability, and Serviceability (RAS) data sources, the method comprising:
collecting RAS data from at least a portion of the plurality of RAS data sources using the PMC; and
enabling an operating system running on the computing platform to access the RAS data collected using the PMC.

2. The method of claim 1, further comprising:
receiving one of a notification or request from the operating system to provide RAS data to the operating system;
collecting the RAS data from the at least a portion of the plurality of RAS data sources using the PMC and writing the RAS data to memory, wherein the RAS data is written to a predetermined memory location in the memory that is accessible to the operating system.

3. The method of claim 2, wherein a notification comprising a doorbell ring is sent to a platform management client mailbox having a doorbell, the method further comprising:
one of invoking an interrupt of the PMC or detecting, via the PMC that the a doorbell of the platform management client mailbox has been rung; and
collecting the RAS data from the at least a portion of the plurality of RAS data sources using the PMC and writing the RAS data to memory in response to the doorbell ring.

4. The method of claim 1, further comprising:
implementing a platform management client mailbox that is accessible to both the PMC and the operating system; and
ringing, via the PMC, a doorbell of the platform management client mailbox when the RAS data has been written to one of the predetermined location in the memory or the platform management mailbox.

5. The method of claim 1, further comprising:
configuring at least one platform RAS data source to generate an RAS event in response to detecting a predetermined condition for a component associated with the RAS data source; and
during runtime operations of the computing platform, generating a RAS event,
receiving, at the PMC, one of a notification of the RAS event or RAS data corresponding to the RAS event.

6. The method of claim 1, wherein the platform includes one or more devices that generate SMART (Self-Monitoring, Analysis and Reporting Technology) data, and wherein collecting the RAS data includes collecting SMART data for at least one of the one or more devices that generate SMART data.

7. The method of claim 1, wherein the processor includes a plurality of Machine Specific Registers (MSRs), and the RAS data that is collected includes RAS data read from at least one MSR.

8. The method of claim 1, wherein the PMC includes on-board memory and the operating system runs in a virtual memory address space mapped to physical memory addresses in the at least one system memory device, further comprising:
mapping memory addresses in the on-board memory for the PMC into the virtual memory address space using Memory-Mapped Input Output (MMIO), creating a MMIO region in the virtual memory address space; and
implementing MMIO access for the on-board memory for the PMC,
wherein the operating system is enabled to read data in the on-board memory for the PMC using memory read requests to the MMIO region in the virtual memory address space.

9. The method of claim 1, wherein the computing platform further includes Universal Extensible Firmware Interface (UEFI) firmware, and wherein at least a portion of the RAS data is collected via use of code in the UEFI firmware.

10. The method of claim 1, wherein the computing platform includes a RAS data source relating to an Advanced Configuration and Power Interface (ACPI) function, and wherein RAS data is collected from the RAS data source using ACPI source language (ASL) code.

11. The method of claim 1, wherein the PMC comprises circuitry that is integrated on the processor.

12. A computing platform, comprising:
a processor, including one or more memory controllers;
for each of the memory controllers, one or more system memory device coupled to that memory controller;
a platform management controller (PMC), either communicatively coupled to the processor or integrated on the processor,
a firmware device, coupled to the processor having system firmware installed therein; and
a plurality of Reliability, Availability, and Serviceability (RAS) data sources, including at least one of,
RAS data sources on the processor; and
RAS data sources on components coupled to the processor,
wherein the platform is configured, upon operation, to,
host an operating system, the operating system either running on platform hardware or running in a virtual machine running on the platform;
map physical memory addresses for at least one system memory device to a virtual memory space in which an operating system is run,
collect RAS data from at least a portion of the plurality of RAS data sources using the PMC;
enable the operating system to access the RAS data collected by the PMC.

13. The computing platform of claim 12, wherein the computing platform, upon operation, is further configured to:
receive one of a notification or request from the operating system to provide RAS data to the operating system;
collect the RAS data from the at least a portion of the plurality of RAS data sources using the PMC and writing the RAS data to memory on the platform, wherein the RAS data is written to a predetermined memory location in the memory that is accessible to the operating system.

14. The computing platform of claim 13, wherein a notification comprising a doorbell ring is sent to a platform management client mailbox having a doorbell, and wherein the computing platform, upon operation, is further configured to:
one of invoke an interrupt of the PMC or detect, via the PMC that the a doorbell of the platform management client mailbox has been rung; and, in response to the doorbell ring,
collect the RAS data from the at least a portion of the plurality of RAS data sources using the PMC and writing the RAS data to the memory that is accessible to the operating system.

15. The computing platform of claim 12, wherein the computing platform, upon operation, is further configured to:
implement a platform management client mailbox that is accessible to both the PMC and the operating system; and
write RAS data collected by the PMC to memory on the platform, wherein the RAS data is written to a predetermined memory location in the memory that is accessible to the operating system; and
ring, via the PMC, a doorbell of the platform management client mailbox when the RAS data has been written to one of the predetermined location in the memory or the platform management mailbox.

16. The computing platform of claim 12, wherein the computing platform, upon operation, is further configured to:
configure at least one platform RAS data source to generate a RAS event in response to detecting a predetermined condition for a component associated with the RAS data source; and
during runtime operations of the computing platform, generate a RAS event in response to detection of the predetermined condition; and
receive, at the PMC, one of a notification of the RAS event or RAS data corresponding to the RAS event.

17. The computing platform of claim 12, wherein the platform includes one or more devices that generates SMART (Self-Monitoring, Analysis and Reporting Technology) data, and wherein collecting the RAS data includes collecting SMART data for at least one of the one or more devices that generate SMART data.

18. The computing platform of claim 12, wherein the processor includes a plurality of Machine Specific Registers (MSRs), and the RAS data that is collected includes RAS data read from at least one MSR.

19. The computing platform of claim 12, wherein the PMC includes on-board memory and the operating system runs in a virtual memory address space mapped to physical memory addresses in the at least one system memory device, and wherein the computing platform, upon operation, is further configured to:
map memory addresses in the on-board memory for the PMC into the virtual memory address space using Memory-Mapped Input Output (MMIO), creating a MMIO region in the virtual memory address space; and
implement MMIO access for the on-board memory for the PMC,
wherein the operating system is enabled to read data in the on-board memory for the PMC using memory read requests to the MMIO region in the virtual memory address space.

20. The computing platform of claim 12, wherein the system firmware comprises Universal Extensible Firmware Interface (UEFI) firmware, and wherein at least a portion of the RAS data is collected via use of code in the UEFI firmware.

21. An apparatus comprising:
an input-output (IO) interface; and
on-board memory,
wherein the apparatus is configured to be communicatively coupled to a processor in a computing platform via the IO interface, the processor including one or more memory controllers to which one or more system memory devices are coupled, the computing platform having a plurality of Reliability, Availability, and Serviceability (RAS) data sources, including at least one of,
RAS data sources on the processor; and
RAS data sources on components coupled to the processor,
wherein the apparatus is configured to, when communicatively coupled to the processor and when the computing platform is operating, at least one of,
collect RAS data from one or more of the plurality of RAS data sources and store the RAS data that is collected in the on-board memory; and
receive RAS data relating to RAS events from one or more of the plurality of RAS data sources and store the RAS data that is received in the on-board memory.

22. The apparatus of claim 21, wherein the computing platform includes one or more devices that generate SMART (Self-Monitoring, Analysis and Reporting Technology) data, and wherein the RAS data includes SMART data collected or received from at least one of the one or more devices that generate SMART data.

23. The apparatus of claim 21, wherein the computing platform is further configured to implement a platform management client mailbox that is accessible to both an operating system running on the computing platform and the apparatus, the platform management client mailbox including a doorbell that is rung by the operating system, and wherein the apparatus is configured to one of detect that the doorbell of the platform management client mailbox has been rung by the operating system or receive an interrupt from the platform management client mailbox in response to the operating system ringing the doorbell of the platform management client mailbox.

24. The apparatus of claim 21, wherein the computing platform is further configured to implement a platform management client mailbox that is accessible to both an operating system running on the computing platform and the apparatus, the platform management client mailbox including a doorbell, and wherein the apparatus is configured to ring the doorbell to inform the operating system that the apparatus has at least one of collected and received RAS data.

25. The apparatus of claim 21, wherein the computing platform, when operating, hosts an operating system running in a virtual memory address space that includes a Memory-Mapped Input Output (MMIO) region in which physical addresses in the on-board memory are mapped to virtual addresses in the MMIO region, and wherein the operating system is enabled to read data stored in the on-board memory of the apparatus by using memory read requests to the MMIO region in the virtual memory address space.
